(19) United States
(12) Patent Application Publication
(10) Pub. No.: US 2004/0049961 A1
(43) Pub. Date: Mar. 18, 2004

(54) Recipe card holder

(76) Inventors: Robert M. Byrne, Lima, OH (US); Kurt F. Hafeken SR., Elida, OH (US)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/462,378

(22) Filed: Jun. 16, 2003

Related U.S. Application Data
(60) Provisional application No. 60/389,417, filed on Jun. 17, 2002.

(51) Int. Cl. G09F 3/20

(52) U.S. Cl. 40/649

(57) ABSTRACT

The present invention provides a recipe card holding device for attachment to a food mixer. The device includes a first end and a second end. The first end attaches to the food mixer, and the second end holds a recipe card. In a first embodiment of the invention, the first end is attached to a food mixer by a mounting portion that is configured to contact a portion of the housing of the food mixer adjacent to the power take off. In other embodiments, the mounting portion is configured to attach to other portions of the housing. An orifice is provided in the mounting portion through which an accessory mounting screw of the food mixer is passed. The second end preferably includes three generally parallel fingers that extend away from an arm that connects the first end and the second end. A recipe card is then inserted between the fingers in an alternating manner.

### CROSS-REFERENCE TO RELATED APPLICATION

This application claims the benefit of U.S. Provisional Application No. 60/389,417, filed Jun. 17, 2002.

### BACKGROUND OF THE INVENTION

1. Field of Invention

The present invention relates to a recipe card holding device, and more particularly, to a recipe card holding device configured for attachment to a food mixer used in the preparation of food.

2. Description of Related Art

Recipes, which are a set of instructions for making a food item by combining various amounts of selected ingredients together in a particular manner, are frequently recorded on recipe cards. Recipe cards are often hand-printed on 3″×5″ or 4″×6″ index cards. It is also a common practice for sellers of ingredients to print recipes on packaging, which can be cut out by consumers to form recipe cards. Recipe cards are also frequently published and sold as sets.

Recipe cards, which are typically stored in recipe card boxes, are usually placed onto the food preparation surface during use. The recipe cards are thus exposed to spills, which can cause staining or damage to the card and in some cases a loss of the recipe printed thereon. Recipe cards placed on food preparation surfaces can also become covered or hidden by ingredients or cookware used during food preparation, making it difficult for the food preparer to quickly locate the recipe card.

### BRIEF SUMMARY OF THE INVENTION

The present invention provides a recipe card holding device comprising a first end and a second end. The first end comprises means for attaching the device to a food mixer, and the second end comprises means for holding a recipe card.

In a first embodiment of the invention, the means for attaching the device to a food mixer comprises a mounting portion configured to contact a portion of the housing of the food mixer adjacent to the power take off. An orifice is provided in the mounting portion through which the accessory mounting screw of the food mixer is passed to attach the recipe card holding device to the food mixer. In a second embodiment of the invention, the mounting portion is configured to contact a portion of the housing of the food mixer at an end of the food mixer opposite the power take off. A third embodiment provides a substantially planar mounting portion that is also configured to contact a portion of the housing of the food mixer at an end of the mixer opposite the power take off. The means for holding a recipe card preferably comprise three generally parallel fingers that extend away from an arm that extends between the first end and the second end. A recipe card is then inserted between the fingers in an alternating manner.

The recipe card holding device according to the invention holds a recipe card in full view of the food preparer and out of danger from being damaged due to spills. The recipe card holding device can be attached and detached from the food mixer quickly and easily without the need for special tools, and can be stored in a drawer when not in use.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a perspective view of the first embodiment of a recipe card holding device according to the invention.

FIG. 2 is a front view of the recipe card holding device shown in FIG. 1.

FIG. 3 is a front view of a second embodiment of a recipe card holding device.

FIG. 4 is a perspective view of another embodiment of a recipe card holding device according to the invention.

FIG. 5 is a back view of a portion of the recipe card holding device shown in FIG. 4 mounted onto a mixer.

FIG. 6 is a back perspective view of a portion of the recipe card holding device shown in FIG. 4 mounted onto a mixer.

FIG. 7 is a is a side view of the recipe card holding device shown in FIG. 4 mounted onto a mixer.

### DETAILED DESCRIPTION OF THE INVENTION

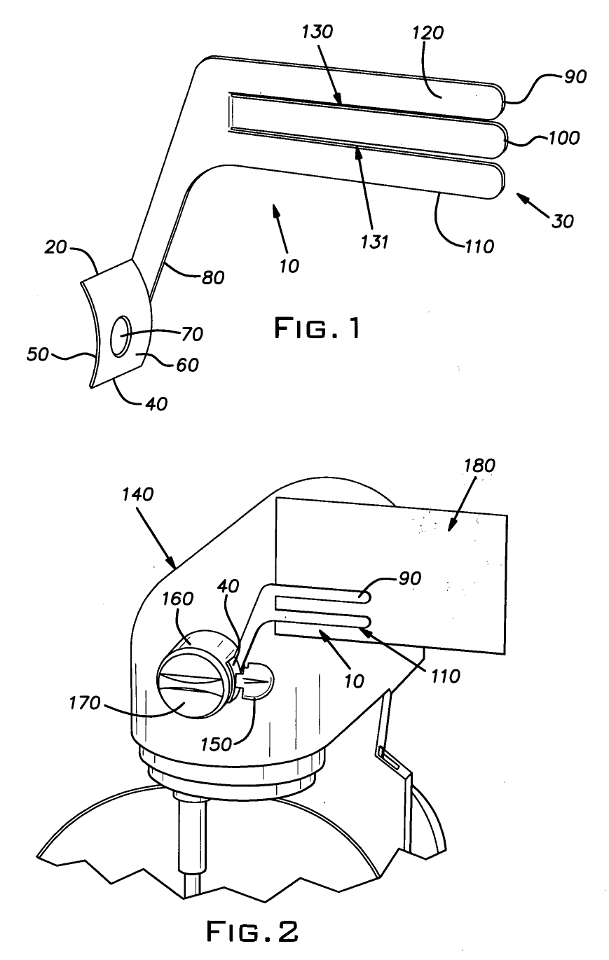

With reference to FIG. 1, a first embodiment of a recipe card holding device 10 according to the invention is illustrated. The recipe card holding device 10 comprises a first end 20 and a second end 30. The first end 20 preferably comprises a mounting portion 40 having a first side 50 and a second side 60. The first side 50 of the mounting portion 40 is configured to contact the housing of a food mixer (not shown). The mounting portion 40 is provided with an opening 70 through which an accessory mounting screw (not shown) can be passed. The accessory mounting screw threads into a threaded aperture in the food mixer and makes contact with the second side 60 of the mounting portion 40 to secure the recipe card holding device 10 to the food mixer.

The first end 20 of the recipe card holding device 10 is connected to the second end 30 by an arm 80. The second end 30 preferably terminates in a top finger 90, a middle finger 100, and a bottom finger 110, each of which extends generally parallel to each other in the same general plane. The front surface 120 of fingers 90, 110 can optionally be provided with a high friction material, such as rubber. Top and bottom slots 130, 131 extend between the fingers 90, 100, 110.

With reference to FIG. 2, the first embodiment of a recipe card holding device 10 according to the invention is shown mounted to a KITCHENAID® food mixer 140. To attach the recipe card holding device 10 to the food mixer 140, a user first unscrews and removes an accessory mounting screw 150 from the food mixer 140. The first side 50 (not shown in FIG. 2) of the mounting portion 40 is then positioned in contact with the housing 160 of the food mixer adjacent to the power take off 170. The opening 70 (not shown in FIG. 2) is aligned such that the accessory mounting screw 150 passes through the opening 70 and threads back into an aperture in the food mixer 140. The head of the accessory mounting screw 150 contacts the second side 60 of the mounting portion 40 to secure the recipe card holding device 10 to the food mixer 140. In this embodiment, the mounting portion preferably has a smaller radius than the radius of the outside surface of the power take off housing. Thus, the mounting portion provides a spring force against the accessory mounting screw 150, which is not configured to bottom out against the power take off housing. The spring force prevents the recipe card holding device from wobbling during operation of the food mixer.

In the first embodiment of the invention, a user threads a recipe card 180 behind the top finger 90, through the top slot 130 (not shown in FIG. 2), in front of the middle finger 100 (not shown in FIG. 2), through the bottom slot 131, and behind the bottom finger 110. The friction provided by the fingers 90, 100, 110 and the stiffness of the recipe card 180 cooperate to hold the recipe card 180 in place. The recipe card 180 is thus easily viewed during preparation of a food item.

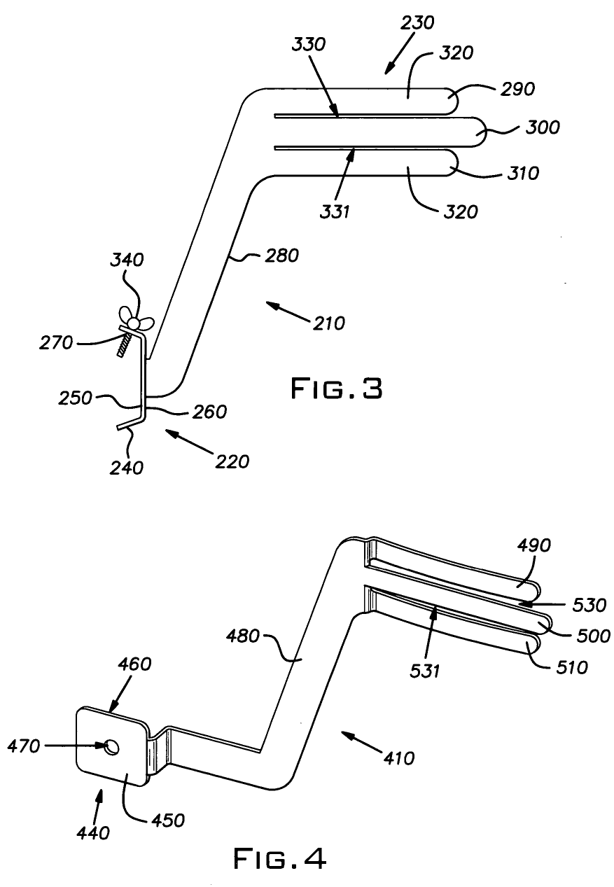

It will be appreciated that the recipe card holding device can be configured to function with a variety of different food mixers simply by varying the means of mounting the device to the food mixer. A second embodiment of the invention is shown in FIG. 3. In the second embodiment, a mounting portion 240 that is generally C-shaped is disposed at the first end 220 of the device 210. A top finger 290, a middle finger 300 and a bottom finger 310 are positioned at the second end 230 of the device 210, and a top slot 330 and a bottom slot 331 are disposed between the fingers. The mounting portion 240 adjacent the arm 280 includes a first side 250 that is shaped to contact the housing of a food mixer other than at the power take off. The mounting portion 240 is provided with an opening 270 sized to allow the threaded portion of a wing screw 340 to pass through. The wing screw 340 threads into an aperture in the housing of the food mixer to secure the recipe card holding device to the food mixer.

The means of holding the recipe card is also not per se critical. In the second embodiment of the invention shown in FIG. 3, the user would thread a recipe card 180 (not shown) in front of the top finger 290, through the top slot 330, behind the middle finger 300, through the bottom slot 331, and in front of the bottom finger 310. In this embodiment, only one finger 300 covers a portion of the recipe card. Other means of holding a recipe card can be used. For example, the holding means could comprise of a spring clip or a stand having a lower edge against which a recipe card can rest. Virtually any means by which the second end of the device secures a recipe card in view of a user can be used.

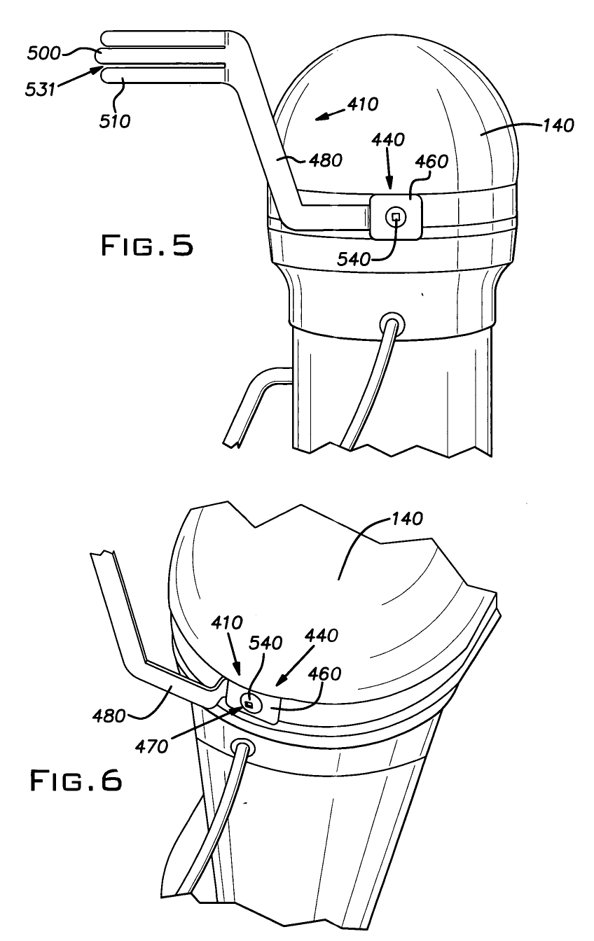

FIG. 4 illustrates a third embodiment of the recipe card holding device 410. In this embodiment, the mounting portion 440 is configured to attach the device 410 to the rear of the food mixer, opposite the power take off housing. In the first embodiment, where the mounting portion 40 engages the power take off housing 170 of the food mixer 140, it is preferred that the food mixer is of the type where the housing tilts back to disengage the mixer bowl. In the third embodiment where the mounting portion 440 is configured to secure the device to the rear of the food mixer, as illustrated in FIGS. 5-7, it is preferred that the mixer is of the type where the mixer bowl may be lifted up to the beaters.

In the third embodiment, illustrated in FIG. 4, the mounting portion 440 is generally planar and comprises an opening 470. The mounting portion 440 has a first side 450 that contacts the housing of the food mixer. When the device 410 is mounted to the food mixer, as illustrated in FIGS. 5, 6 and 7, an accessory mounting screw 540 with a head that is preferably larger than the opening 470 is inserted through the opening 470 and into a threaded portion of the housing of the food mixer 140 so that the head of the accessory mounting screw 540 contacts the second side 460 of the mounting portion 440 and attaches the device 410 to the food mixer 140.

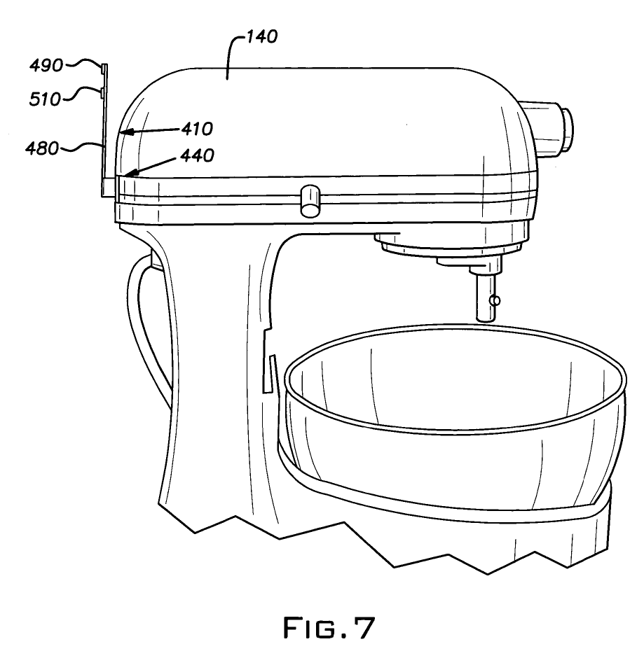

The third embodiment comprises a top finger 490, a middle finger 500 and a bottom finger 510. A top slot 530 is disposed between the top finger 490 and the middle finger 500. A bottom slot 531 is disposed between the middle finger 500 and the bottom finger 510. A side view of the device 410 mounted to a food mixer 140 is illustrated in FIG. 7. The top finger 490, the middle finger 500, and the bottom finger 510 are generally in the same plane and are oriented parallel to one another. However, as shown in the side view in FIG. 7, and in FIG. 4, the top finger 490 and the bottom finger 510 are in a plane that is slightly farther away from the plane defined by the first side 450 of the mounting portion 440 as compared to the middle finger 500. In this embodiment, a recipe card may be inserted in front of the top finger 490, through the top slot 530, behind the middle finger 500, through the bottom slot 531, and in front of the bottom finger 510. Only the middle finger 500 covers the recipe card in this third embodiment, similar to the second embodiment.

The means of mounting the device to the food mixer is not per se critical, and a variety of means can be employed. For example, the mounting portion can slide into a receiving slot provided in the housing of a food mixer. Alternatively, a magnet can be provided at the first end for magnetically attaching the recipe card holding device to the food mixer. Virtually any means by which the first end of the device is secured to the food mixer can be used.

In the presently most preferred embodiment of the invention, the recipe card holding device is formed of metal and is shaped by stamping or other metal working means. Alternatively, the recipe card holding device is formed of a polymer, such as polycarbonate, which is both transparent and strong. The surface of the recipe card holding device can be provided with high friction materials such as rubber, or can be textured (e.g., by sandblasting) to provide higher friction.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed:

1. A recipe card holding device for attachment to a housing of a food mixer, the device comprising a first end, a second end, and an arm extending between and connecting the first end and second ends, the first end comprising means for attaching the device to the food mixer, and the second end comprising means for holding a recipe card.

2. The device according to claim 1 wherein the means for holding a recipe card comprises a plurality of fingers and a plurality of slots extending between the fingers, and wherein a recipe card may be inserted behind one or more of the fingers and through the slots to secure the recipe card.

3. The device according to claim 2 comprising:
a top finger, a middle finger, and a bottom finger;
a top slot extending between the top and middle fingers; and
a bottom slot extending between the middle and bottom fingers.

4. The device according to claim 1 wherein the means for attaching the device to the food mixer comprises a mounting portion having a first side, a second side, and an opening configured to receive attachment means.

5. The device according to claim 4, wherein the first side of the mounting portion contacts the housing of the food mixer, and the attachment means comprises an accessory mounting screw configured to extend through the opening of the device and into a threaded portion of the housing of the food mixer.

6. The device according to claim 4 wherein the mounting portion is planar.

7. The device according to claim 4 wherein the mounting portion is C-shaped.

8. The device according to claim 1 wherein the device is formed from a material selected from the group consisting of metals and polymers.

9. The device according to claim 1 wherein the device is formed from a transparent polymer.

10. The device according to claim 1 wherein at least a portion of the surface of the device is coated with a high friction material selected from the group consisting of: rubber, polymers, and adhesives.

11. The device according to claim 1 wherein at least a portion of the surface of the device has a high friction texture.

12. A method of supporting a recipe card for display using a recipe card holding device, comprising:
attaching a recipe card holding device to a food mixer housing, the device comprising a first end, a second end, and an arm extending between and connecting the first end and second ends, the first end comprising means for attaching the device to the food mixer, and the second end comprising means for holding a recipe card, the means for holding a recipe card comprising a plurality of fingers and a plurality of slots extending between the fingers; and
threading a recipe card behind one or more of the fingers and through each of the slots, thereby engaging the recipe card.

13. The method according to claim 12 wherein the recipe card holding device is formed from a material selected from the group consisting of metals and polymers.

14. The method according to claim 12 wherein at least a portion of the device is provided with a high-friction texture to assist in engaging the recipe card.
